(19) United States
(12) Patent Application Publication
(10) Pub. No.: US 2016/0288934 A1
(43) Pub. Date: Oct. 6, 2016

(54) A SEALANT FILLING DEVICE

(71) Applicant: SHENZHEN CHINA STAR OPTOELECTRONICS TECHNOLOGY CO., LTD, Shenzhen, Guangdong (CN)

(72) Inventor: Longxian ZHANG, Shenzhen, Guangdong (CN)

(21) Appl. No.: 14/413,155

(22) PCT Filed: Dec. 26, 2013
(86) PCT No.: PCT/CN2013/090605

§ 371 Date: Jan. 6, 2015

(30) Foreign Application Priority Data
Dec. 23, 2013 (CN) 201310719161.1

(51) Int. Cl. B65B 3/28; B65B 65/02; B05C 11/10; B65B 3/04

(52) U.S. Cl. CPC B65B 3/28; B65B 3/04; B65B 65/02; B05C 11/1002

(57) ABSTRACT

A sealant filling device comprises a sealant board and a plurality of injectors installed on it, the sealant board comprises a base and a sealing cover which opening a plurality of sealing holes, the injector comprises a feeding hole which is opposite to the sealing holes, the sealant can be poured into the injector from the sealing holes to the feeding hole, a spring between the top of the injector and the sealing cover is provided for moving in control, while the volume of the sealant reaches the preset value, the spring will be control to move and seal off the sealing hole to stop sealing. If the volume of the sealant reaches the preset volume, then the controller IC will drive the spring moving and sealing off the sealing hole by controlling of the motor. The sealant volume in each injector can be separated distributed.

### FIELD OF THE INVENTION

The invention relates to a sealing device, more particularly relates to a filling device for filling the sealant.

### BACKGROUND OF THE INVENTION

The sealant can be poured into the several injectors from the sealing hole in the same time and same speed with squeezing. Actually, the coating length of each injector is different. So the sealant wastage in each injector is also different. The actual sealant wastage in two sides is more than that of in the middle. When the coating process is over, the sealant in both two sides is exhausted and the sealant in the middle is remained. Then the unused sealant will be wasted and the remained sealant in each injector is non-uniform.

### SUMMARY OF THE INVENTION

To overcome the above disadvantages, the main purpose of the present invention is provided a sealant filling device which the volume can be preset and adjusted to make the coating uniform by automatic controlled during filling sealant.

The present invention provides a sealant filling device comprising a sealant board and a plurality of injectors installed on it. The sealant board comprises a base and a sealing cover which opening a plurality of sealing holes. The injector clamped on the base comprises a feeding hole which is opposite to the sealing holes. The sealant can be poured into the injector from the sealing holes to the feeding hole. A spring between the top of the injector and the sealing cover is provided for moving in control. While the volume of the sealant reaches the preset value, the spring will be control to move and seal off the sealing hole to stop sealing.

In the preferred embodiment, a weight sensor on the bottom of the injector is provided for measuring the sealant weight of the injector, and a height sensor located at the both sides of the injector is provided for measuring if the height of the sealant reaches the highest preset value or not. The weight sensor is mounted under the packaging barrel.

In the preferred embodiment, the injector comprises a controller IC and a motor. The controller IC is electrical connecting with the weight sensor and the motor, the motor is also electrical connecting with the spring. The controller IC is provided for receiving the detection signal from the weight sensor and driving the spring moving according to the compared results between the measured value and the standard value of the detection signal by controlling the motor.

In the preferred embodiment, the controller IC is electrically connecting with the height sensor and the motor. The motor is electrically connecting with the spring. The controller IC is provided for receiving the detection signal from the height sensor and driving the spring moving according to the compared results between the measured value and the standard value of the detection signal by controlling the motor.

After detecting of the weight and the height of the sealant, the detecting result is acquired that the volume of the sealant whether reaches the preset value or not. The spring can be adjusted to seal off the sealing hole by automatic controlling the motor. That is to say, the sealing process can be automatic controlled and the weight of the sealant in each injector can be separated preset. The weight of the sealant can be distributed basic on the necessary. If the consume of sealant in the side injector is much more the middle injector, than the preset sealant in the side injector will be more than that of in the middle injector. So after the sealant pouring, the sealant consume is balanced which in the side injector and the middle injector. As a result, the sealant will be not remained in any injector to be wastered.

In the preferred embodiment, the height sensor comprises a signal generator and a signal receiver in the same horizontal line, while the height of the injected sealant reaches the preset value, the signal receiver will be not receive the signal from the signal generator, and the signal receiver will send a broken signal to the controller IC to drive the spring moving and sealing off the sealing hole by controlling the motor. The signal source of the signal generator is infrared ray. The signal generator and the signal receiver are separated placed on the both sides of the injector, the distance which between the signal generator and the injector is equal to that of between the signal receiver and the injector. The distance between the signal generator and the edge of the injector is 1.5-2 cm.

In the preferred embodiment, the spring can be adhered at the bottom of the sealing cover for preventing the sealant flowing out from the two side of the sealing holes. The sealing effect is better than before.

Compared to the prior art, in the sealant filling device of the present invention, the spring is connecting with the weigh sensor and the height sensor. The weight sensor is provided for determining the weight of the sealant in the injector. If the volume of the sealant reaches the preset volume, then the weight sensor or the height sensor will send a feedback signal to the controller IC to drive the spring moving and sealing off the sealing hole by controlling of the motor. With automatically detesting the filling process, the moderate sealant will be filled into each injector. On the one hand, the sealant volume in each injector can be separated distributed, on the other hand, the filling precision and the degree of automation will be improved and the consume of the sealant will be reduced with automatically controlling the filling process.

### BRIEF DESCRIPTION OF THE DRAWINGS

FIG. 1 is a schematic view of a sealant filling device according to the present invention;

FIG. 2 is a schematic view of a sealant filling device in the first embodiment according to the present invention;

FIG. 3 is a circuitous philosophy view of a sealant filling device according to the present invention;

FIG. 4 is a schematic view of a sealant filling device in the second embodiment according to the present invention; and

FIG. 5 is a side view of a sealant filling device in the second embodiment according to the present invention.

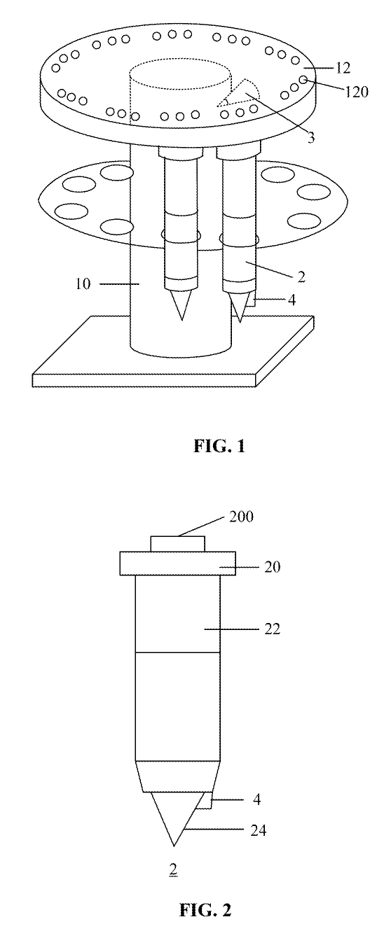

### DESCRIPTION OF THE PREFERRED EMBODIMENTS

The sealant filling device of the present invention is provided to solve the problems that the sealant volume and consume are unbalance to make part of sealant remained during the synchronous pouring process. The sealant filling device comprises a sealant board 1 and a plurality of injectors 2 installed on it. The sealant board 1 comprises a base 10 and a sealing cover 12 which opening a plurality of sealing holes 120. The injectors 2 clamped on the base 10 comprises a feeding hole 200 which is opposite to the sealing holes 120. The sealant can be poured into the injector 2 from the sealing holes 120 to the feeding hole 200. A spring 3 between the top of the injector 2 and the sealing cover 12 is provided for moving in control, while the volume of the sealant reaches the preset value, the spring 3 will be control to move and seal off the sealing hole 120 to stop sealing. Perferlly, the spring 3 can be mounted on the bottom of the sealing cover 12 of the injector 2, so the sealant would not be flowed out from the injector to seal off the feeding hole 200 with the closely adhering between the spring 3 and the sealing cover 12.

The sealing cover 12 of the sealant board 1 is located on the base 10. The base 10 comprises a plurality of champers for champing the bottom of the injectors 2. The injectors 2 can be stand up by clamping the injectors from the upper lever and the lower lever. The injector 2 resisted to the sealing cover 12 opens a feeding hole 200 on the top which is opposite to the sealing holes 120. The injector 2 comprises a top cover 20, a packaging barrel 22 and an injector head 24. A plurality of sealing holes 200 are opening on the top cover 20. The injector head 24 is mounted at the bottom of the packaging barrel 22. The sealant can be poured into the packaging barrel 22 from the sealing hole 200 and be poured out from the injector head 24. The sealant can be poured out from several injectors with the champers circling around the rotation axis.

Refer to FIG. 2, in the first embodiment, a weight sensor 4 on the bottom of the injector 2 is provided for measuring the sealant weight of the injector 2 to determine the sealant whether reaches the preset weight or not. If the feeding sealant reaches the preset weight, then the weight sensor 4 sends a feedback signal to the controller IC. Refer to FIG. 3, the injector 2 comprises a controller IC 2a and a motor 2b, the controller IC 2a is electrical connecting with the weight sensor 4 and the motor 2b, the motor 2b is also electrical connecting with the spring 3, the controller IC 2a is provided for receiving the detection signal from the weight sensor 4 and driving the spring 3 moving to seal off the sealing hole 120 of the sealing cover 12 according to the compared results between the measured value and the standard value of the detection signal by controlling the motor 2b.

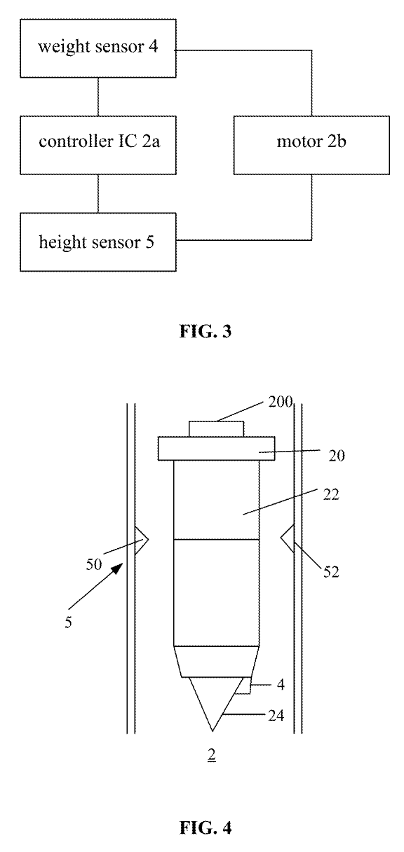

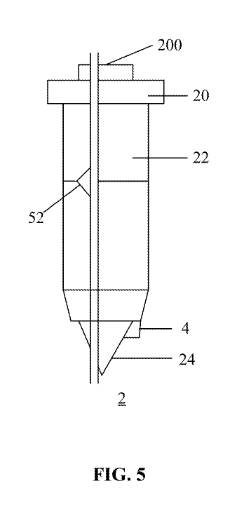

Refer to FIGS. 3-5, in the second embodiment, a height sensor 5 located at the both sides of the injector 2 is provided for measuring whether the height of the sealant reaches the highest preset value or not. The height sensor 5 comprises a signal generator 50 and a signal receiver 52 in the same horizontal line, while the height of the injected sealant reaches the preset value, the signal receiver 52 will be not receive the signal from the signal generator 50, and the signal receiver 52 will send a broken signal to the controller IC 2a to drive the spring 3 moving and sealing off the sealing hole by controlling the motor. The signal generator 50 and the signal receiver 52 are separated placed on the both sides of the injector 2, the distance which between the signal generator 50 and the injector 2 is equal to that of between the signal receiver 52 and the injector 2. The signal source of the signal generator 50 is infrared ray. The distance between the signal generator 50 and the edge of the injector 2 is 1.5-2 cm.

The volume of the sealant can be figured out with the weight and the height of the sealant in the package barrel 22. When the sealant weight reaches the top preset value, then the weight sensor 4 will send a feedback signal to the controller IC 2a to drive the spring 3 moving to seal off the sealing hole 120 of the sealing cover 12 Similarly, when the sealant height reaches the preset value, the signal receiver 52 will be not receive the signal from the signal generator 50, and the signal receiver 52 will send a broken signal to the controller IC 2a to drive the spring 3 moving and sealing off the sealing hole 120 by controlling the motor. Accordingly, the spring 3 can be controlled to move according to the compared results between the measured value and the standard value of the detection signal by controlling the motor 2b.

The sealant volume in each injector can be separated distributed. More sealant can be filled the injector with the bigger coating area. The sealant volume can be fine controlled with the weight sensor and the height sensor so as to precisely distribute the volume of the sealant. As a result, the filling precision and the degree of automation will be improved and the remaining and producing of the sealant will be reduced with automatically controlling the filling process.

What is claimed is:

1. A sealant filling device, comprising a sealant board and a plurality of injectors installed on it, the sealant board comprising a base and a sealing cover which opening a plurality of sealing holes, the injector clamped on the base comprises a feeding hole which is opposite to the sealing holes, the sealant can be poured into the injector from the sealing holes to the feeding hole, wherein a weight sensor on the bottom of the injector is provided for measuring the sealant weight of the injector, a height sensor located at the both sides of the injector is provided for measuring if the height of the sealant reaches the highest preset value or not, a spring between the top of the injector and the sealing cover is provided for moving in control, while the weight or the height of the sealant reach the preset value, the spring will be control to move and seal off the sealing hole to stop sealing.

2. The sealant filling device according to claim 1, wherein the injector comprises a controller IC and a motor, the controller IC is electrical connecting with the weight sensor and the motor, the motor is also electrical connecting with the spring, the controller IC is provided for receiving the detection signal from the weight sensor and driving the spring moving according to the compared results between the measured value and the standard value of the detection signal by controlling the motor.

3. The sealant filling device according to claim 2, wherein the controller IC is electrically connecting with the height sensor and the motor, and the motor is electrically connecting with the spring, the controller IC is provided for receiving the detection signal from the height sensor and driving the spring moving according to the compared results between the measured value and the standard value of the detection signal by controlling the motor.

4. The sealant filling device according to claim 3, wherein the height sensor comprises a signal generator and a signal receiver in the same horizontal line, while the height of the injected sealant reaches the preset value, the signal receiver will be not receive the signal from the signal generator, and the signal receiver will send a broken signal to the controller IC to drive the spring moving and sealing off the sealing hole by controlling the motor.

5. The sealant filling device according to claim 4, wherein the signal generator and the signal receiver are separated placed on the both sides of the injector, the distance which between the signal generator and the injector is equal to that of between the signal receiver and the injector.

6. The sealant filling device according to claim 5, wherein the distance between the signal generator and the edge of the injector is 1.5-2 cm.

7. The sealant filling device according to claim 5, wherein the signal source of the signal generator is infrared ray.

8. The sealant filling device according to claim 1, wherein the injector comprises a top cover, a packaging barrel and an injector head, a plurality of sealing holes are opening on the top cover, the injector head is mounted at the bottom of the packaging barrel, the sealant can be poured into the packaging barrel from the sealing hole and be poured out from the injector head.

9. The sealant filling device according to claim 8, wherein the weight sensor is mounted under the packaging barrel.

10. A sealant filling device, comprising a sealant board and a plurality of injectors installed on it, the sealant board comprising a base and a sealing cover which opening a plurality of sealing holes, the injector clamped on the base comprising a feeding hole which is opposite to the sealing holes, the sealant can be poured into the injector from the sealing holes to the feeding hole, a spring between the top of the injector and the sealing cover provided for moving in control, while the volume of the sealant reaches the preset value, the spring will be control to move and seal off the sealing hole to stop sealing.

11. The sealant filling device according to claim 10, wherein a weight sensor on the bottom of the injector is provided for measuring the sealant weight of the injector.

12. The sealant filling device according to claim 10, wherein a height sensor located at the both sides of the injector is provided for measuring if the height of the sealant reaches the highest preset value or not.

13. The sealant filling device according to claim 11, wherein the injector comprises a controller IC and a motor, the controller IC is electrical connecting with the weight sensor and the motor, the motor is also electrical connecting with the spring, the controller IC is provided for receiving the detection signal from the weight sensor and driving the spring moving according to the compared results between the measured value and the standard value of the detection signal by controlling the motor.

14. The sealant filling device according to claim 12, wherein the controller IC is electrically connecting with the height sensor and the motor, the motor is electrically connecting with the spring, the controller IC is provided for receiving the detection signal from the height sensor and driving the spring moving according to the compared results between the measured value and the standard value of the detection signal by controlling the motor.

15. The sealant filling device according to claim 14, wherein the height sensor comprises a signal generator and a signal receiver in the same horizontal line, while the height of the injected sealant reaches the preset value, the signal receiver will be not receive the signal from the signal generator, and the signal receiver will send a broken signal to the controller IC to drive the spring moving and sealing off the sealing hole by controlling the motor.

16. The sealant filling device according to claim 15, the signal generator and the signal receiver are separated placed on the both sides of the injector, the distance which between the signal generator and the injector is equal to that of between the signal receiver and the injector.

17. The sealant filling device according to claim 16, wherein the distance between the signal generator and the edge of the injector is 1.5-2 cm.

18. The sealant filling device according to claim 10, wherein the injector comprises a top cover, a packaging barrel and an injector head, a plurality of sealing holes are opening on the top cover, the injector head is mounted at the bottom of the packaging barrel, the sealant can be poured into the packaging barrel from the sealing hole and be poured out from the injector head.

19. The sealant filling device according to claim 18, wherein the weight sensor is mounted under the packaging barrel.
